(19) United States
(12) Patent Application Publication
(10) Pub. No.: US 2021/0358661 A1
(43) Pub. Date: Nov. 18, 2021

(54) METHOD OF MANUFACTURING FLEXIBLE CONDUCTIVE WIRE, FLEXIBLE CONDUCTIVE WIRE, AND DISPLAY DEVICE

(71) Applicant: TCL CHINA STAR OPTOELECTRONICS TECHNOLOGY CO., LTD., Shenzhen, Guangdong (CN)

(72) Inventors: Yuan SHAO, Shenzhen, Guangdong (CN); Chunqiu YAN, Shenzhen, Guangdong (CN); Hsiaohsien CHEN, Shenzhen, Guangdong (CN)

(73) Assignee: TCL CHINA STAR OPTOELECTRONICS TECHNOLOGY CO., LTD., Shenzhen, Guangdong (CN)

(21) Appl. No.: 16/620,916

(22) PCT Filed: Nov. 27, 2019
(86) PCT No.: PCT/CN2019/121125

§ 371 Date: Dec. 10, 2019

(30) Foreign Application Priority Data
Nov. 13, 2019 (CN) 201911105739.8

(51) Int. Cl. H01B 13/00; H01B 5/14; H01B 3/10; H01B 19/04; H01B 1/22

(52) U.S. Cl. CPC H01B 13/0026; H01B 5/14; B82Y 20/00; H01B 19/04; H01B 1/22; H01B 3/105

(57) ABSTRACT

A method of manufacturing a flexible conductive wire, a flexible conductive wire, and a display device are provided. The method manufacturing the flexible conductive wire includes: forming a zinc oxide nano-monomer into a patterned substrate, coating a carboxylated silver/3,4-ethylenedioxythiophene: polystyrenesulfonic acid solution on the patterned substrate, and curing the patterned substrate and the carboxylated silver/3,4-ethylenedioxythiophene: polystyrenesulfonic acid solution to form a flexible conductive wire. Display performance of a display panel can be improved.

### FIELD OF INVENTION

The present disclosure relates to the field of display panel technologies, and more particularly to a method of manufacturing a flexible conductive wire, a flexible conductive wire, and a display device.

### BACKGROUND OF INVENTION

With the continuous development of electronic and display technologies. The flexible displays have many advantages such as light weight, small thickness, long life, and bendability, which have gradually gained the favor of research teams and become a next generation display technology with the most development potential. The realization of flexible displays, in addition to changes to existing manufacturing processes and structural designs, new requirements and challenges are also placed on material properties. Flexible traces, as an important part of flexible displays, require good thermal stability and mechanical properties.

Therefore, how to form a flexible conductive wire having good thermal properties and mechanical properties at the same time becomes a technical problem to be solved by those skilled in the art.

### SUMMARY OF INVENTION

Embodiments of the present application provide a method of manufacturing a flexible conductive wire, a flexible conductive wire, and a display device to solve issues of thermal stability and mechanical properties of a flexible conductive wire in the prior art.

An embodiment of the present application provides a method of manufacturing a flexible conductive wire, comprising: forming a zinc oxide nano-monomer into a patterned substrate; coating a carboxylated silver/3,4-ethylenedioxythiophene: polystyrenesulfonic acid solution on the patterned substrate; and curing the patterned substrate and the carboxylated silver/3,4-ethylenedioxythiophene: polystyrenesulfonic acid solution to form a flexible conductive wire.

In some embodiments, forming the zinc oxide nano-monomer to form the patterned substrate comprises: taking zinc nitrate hexahydrate as a precursor, hydrazine hydrate and potassium iodide as additives, and performing a hydrothermal treatment at 140 to 180° C. for 22 to 25 hours to obtain clusters of the zinc oxide nano-monomer; and forming the zinc oxide nano-monomer into the patterned substrate by a yellow light process.

In some embodiments, a method of configuring the carboxylated silver/3,4-ethylenedioxythiophene: polystyrenesulfonic acid solution comprises: stirring 3,4-ethylenedioxythiophene, polystyrenesulfonic acid, and carboxylated silver nanowires for 3 to 120 minutes under a constant temperature water bath at 50 to 100° C. to obtain a mixture; and adding an alcohol solvent, a catalyst, and a light stabilizer to the mixture to obtain the carboxylated silver/3,4-ethylenedioxythiophene: polystyrenesulfonic acid solution.

In some embodiments, before stirring 3,4-ethylenedioxythiophene, polystyrenesulfonic acid, and carboxylated silver nanowires for 3 to 120 minutes under the constant temperature water bath at 50 to 100° C. to obtain the mixture, the method comprises: soaking or irradiating the carboxylated silver nanowires.

In some embodiments, before stirring 3,4-ethylenedioxythiophene, polystyrenesulfonic acid, and carboxylated silver nanowires for 3 to 120 minutes under the constant temperature water bath at 50 to 100° C. to obtain the mixture, the method comprises: heat treating 3,4-ethylenedioxythiophene and polystyrenesulfonic acid.

In some embodiments, the carboxylated silver nanowires have a length of 5 to 30 um.

In some embodiments, curing the patterned substrate and a mixture to form the flexible conductive wire comprises: spraying silver carboxylate/3,4-ethylenedioxythiophene: polystyrene sulfonic acid solution onto the patterned substrate to form a wet film, and drying the wet film.

In some embodiments, curing the patterned substrate and the carboxylated silver/3,4-ethylenedioxythiophene: polystyrenesulfonic acid solution to form the flexible conductive wire comprises: drying and curing the wet film at 40 to 120° C. to form the flexible conductive wire.

An embodiment of the present application further provides a flexible conductive wire, comprising: a substrate, a zinc oxide nano-monomer, a carboxylated silver layer, and a 3,4-ethylenedioxythiophene: polystyrenesulfonic acid layer, wherein the zinc oxide nano-monomer is formed on a substrate and forms a patterned substrate, the carboxylated silver layer is overlapped on the patterned substrate of the zinc oxide nano-monomer, and the 3,4-ethylenedioxythiophene: polystyrenesulfonic acid layer is coated on the carboxylated silver layer.

In some embodiments, the zinc oxide nano-monomer is formed into the patterned substrate by a yellow light process.

In some embodiments, the carboxylated silver layer comprises carboxylated silver nanowires, and the carboxylated silver nanowires having a length of 5 to 30 um.

In some embodiments, the carboxylated silver nanowires are soaked or illuminated.

In some embodiments, the 3,4-ethylenedioxythiophene: polystyrenesulfonic acid layer is subjected to heat treatment.

In some embodiments, the 3,4-ethylenedioxythiophene: polystyrene sulfonic acid layer comprises an alcohol solvent, a catalyst, and a light stabilizer.

An embodiment of the present application further provides a display device comprising a flexible conductive wire. The flexible conductive wire comprises a substrate, a zinc oxide nano-monomer, a carboxylated silver layer, and a 3,4-ethylenedioxythiophene: polystyrenesulfonic acid layer, the zinc oxide nano-monomer is formed on a substrate and forms a patterned substrate, the carboxylated silver layer is overlapped on the patterned substrate of the zinc oxide nano-monomer, and the 3,4-ethylenedioxythiophene: polystyrenesulfonic acid layer is coated on the carboxylated silver layer.

In some embodiments, the zinc oxide nano-monomer is formed into the patterned substrate by a yellow light process.

In some embodiments, the carboxylated silver layer comprises carboxylated silver nanowires, and the carboxylated silver nanowires having a length of 5 to 30 um.

In some embodiments, the carboxylated silver nanowires are soaked or illuminated.

In some embodiments, the 3,4-ethylenedioxythiophene: polystyrenesulfonic acid layer is subjected to heat treatment.

In some embodiments, the 3,4-ethylenedioxythiophene: polystyrene sulfonic acid layer comprises an alcohol solvent, a catalyst, and a light stabilizer.

Beneficial effects of the present application are that: in embodiments of the present application, since a carboxylated silver/3,4-ethylenedioxythiophene: polystyrenesulfonic acid solution is coated on the substrate of the zinc oxide nanomonomer, such that a highly conductive carboxylated silver layer and a 3,4-ethylenedioxythiophene: polystyrenesulfonic acid layer are formed on the substrate, thereby, a flexible conductive wire having good tensile properties as well as thermal stability is formed.

### DESCRIPTION OF DRAWINGS

In order to more clearly illustrate the technical solutions in the embodiments of the present application, the drawings used in the description of the embodiments will be briefly described below. Obviously, the drawings in the following description are only some embodiments of the present application. Other drawings can also be obtained from those skilled in the art based on these drawings without paying any creative effort.

FIG. 1 is a schematic flowchart of a method of manufacturing a flexible conductive wire according to an embodiment of the present application.

FIG. 2 is another schematic flowchart of a method of manufacturing a flexible conductive wire according to an embodiment of the present application.

FIG. 3 is a schematic structural view of a flexible conductive wire according to an embodiment of the present application.

### DETAILED DESCRIPTION OF PREFERRED EMBODIMENTS

The technical solutions in the embodiments of the present invention will be clearly and completely described in the following with reference to the accompanying drawings. It is apparent that the described embodiments are only a part of the embodiments of the present invention, and not all of them. All other embodiments obtained by those skilled in the art based on the embodiments of the present invention without creative efforts are within the scope of the present invention.

Conductive wires are required in flexible displays. Current conductive wires are usually made of a metal material. For example, a copper wire is used as the conductive wire. Conductive wires made of copper have good electrical conductivity, excellent chemical resistance, and can be produced on a large scale. However, if a conductive wire made of copper is applied to a flexible display, it is not suitable for application to a flexible display due to its poor tensile properties. Therefore, the present application provides a method of manufacturing a flexible conductive wire and a flexible conductive wire with good thermal stability and mechanical properties. Hereinafter, the method of manufacturing the flexible conductive wire and the flexible conductive wire will be described in detail.

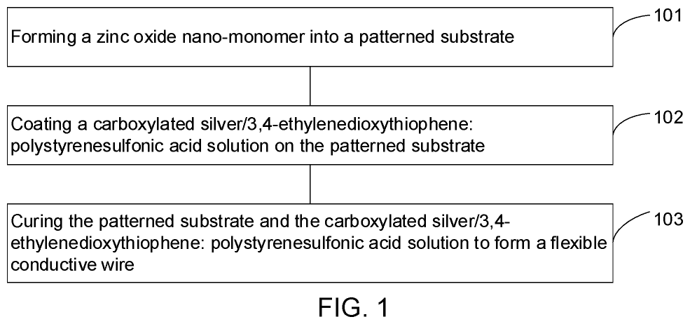

Referring to FIG. 1, FIG. 1 is a schematic flowchart of a method of manufacturing a flexible conductive wire according to an embodiment of the present application. An embodiment of the present application provides a method of manufacturing a flexible conductive wire, comprising:

Step 101, forming a zinc oxide nano-monomer into a patterned substrate.

It should be noted that the zinc oxide nano-monomer may be a zinc oxide nanowire or a zinc oxide nanorod. Patterning of the substrate may be performed by patterning the zinc oxide nano-monomer onto the substrate in a patterned form. Specifically, the patterning of the zinc oxide nano-monomer to the substrate may be performed by a yellow light process. That is, process steps such as exposure and development. The zinc oxide nano-monomer is patterned onto the substrate to form a base substrate having the substrate and the zinc oxide nano-monomer.

Specifically, the substrate is a flexible substrate, for example, the flexible substrate is a PI film. The flexible substrate is not described in detail in the embodiment of the present application.

Step 102, coating a carboxylated silver/3,4-ethylenedioxythiophene: polystyrenesulfonic acid solution on the patterned substrate. It should be noted that, first, it is necessary to configure a carboxylated silver/3,4-ethylenedioxythiophene: polystyrenesulfonic acid solution. The carboxylated silver/3,4-ethylenedioxythiophene: polystyrenesulfonic acid solution is then applied to the substrate. Specifically, the carboxylated silver/3,4-ethylenedioxythiophene: polystyrenesulfonic acid solution is configured by carboxylated silver, 3,4-ethylenedioxythiophene, polystyrenesulfonic acid, and an alcohol solvent. The carboxylated silver/3,4-ethylenedioxythiophene: polystyrenesulfonic acid has good electrical conductivity.

Step 103, curing the patterned substrate and the carboxylated silver/3,4-ethylenedioxythiophene: polystyrenesulfonic acid solution to form a flexible conductive wire.

It should be noted that after the carboxylated silver/3,4-ethylenedioxythiophene: polystyrenesulfonic acid solution is cured, a carboxylated silver layer and a 3,4-ethylenedioxythiophene: polystyrenesulfonic acid layer are formed. The carboxylated silver layer and the 3,4-ethylenedioxythiophene: polystyrenesulfonic acid layer may be coated on the substrate.

The carboxylated silver layer has good electrical conductivity and thermal stability because the 3,4-ethylenedioxythiophene: polystyrenesulfonic acid layer is coated on the carboxylated silver layer. The 3,4-ethylenedioxythiophene: polystyrenesulfonic acid layer can effectively prevent oxidation of the carboxylated silver layer, thereby ensuring stable conductivity of the flexible conductive wire. In addition, since the carboxylated silver layer and the zinc oxide nano-monomer are linearly joined together, stress generated during the process and during the bending process can be effectively reduced. The flexible conductive wire is ensured to have better scalability, thereby forming a flexible conductive wire having good mechanical properties and thermal stability.

In embodiments of the present application, carboxylated silver/3,4-ethylenedioxythiophene: polystyrenesulfonic acid solution is coated on the substrate of the zinc oxide nano-monomer. A highly conductive carboxylated silver layer and a 3,4-ethylenedioxythiophene: polystyrenesulfonic acid layer are formed on the substrate. The carboxylated silver layer has good electrical conductivity and thermal stability. Because the 3,4-ethylenedioxythiophene: polystyrene sulfonic acid layer is coated on the carboxylated silver layer, the 3,4-ethylenedioxythiophene: polystyrene sulfonic acid layer can effectively prevent the carboxylated silver layer from being oxidized. Thereby ensuring that the flexible conductive wire has stable electrical conductivity. In addition, since the carboxylated silver layer and the zinc oxide nano-monomer are linearly joined together, stress generated during the process and during the bending process can be effectively reduced. The flexible conductive wire is ensured to have better scalability, thereby forming a flexible conductive wire having good tensile properties and thermal stability.

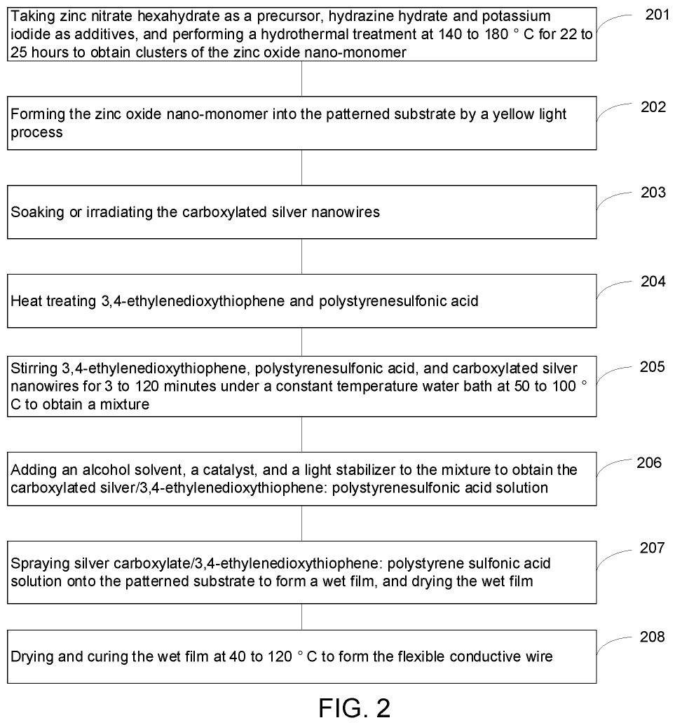

Referring to FIG. 2, FIG. 2 is another schematic flowchart of a method of manufacturing a flexible conductive wire according to an embodiment of the present application. An embodiment of the present application provides a method of manufacturing a flexible conductive wire, comprising:

Step 201, taking zinc nitrate hexahydrate as a precursor, hydrazine hydrate and potassium iodide as additives, and performing a hydrothermal treatment at 140 to 180° C. for 22 to 25 hours to obtain clusters of the zinc oxide nano-monomer.

It should be noted that the hydrothermal condition refers to the use of zinc nitrate hexahydrate as the precursor in a sealed container, and the additions of hydrazine hydrate and potassium iodide in a sealed container, so that the temperature inside the sealed container is maintained at 140 to 180° C. The hydrothermal treatment time is 22 to 25 hours, and finally the nano-monomer of zinc oxide is obtained. It is to be understood that the zinc oxide nano-monomer may be a zinc oxide nanowire, a zinc oxide nanorod, or the like. Specifically, the temperature can be 140° C., 150° C., and 180° C. The hydrothermal treatment time can be 22 hours, 24 hours, and 25 hours.

Step 202, forming the zinc oxide nano-monomer into the patterned substrate by a yellow light process.

It should be noted that the patterning of the zinc oxide nano-monomer to the substrate may be performed by a yellow light process. That is, process steps such as exposure and development. The zinc oxide nano-monomer is patterned onto the substrate to form a base substrate having the substrate and the zinc oxide nano-monomer.

Step 203, soaking or irradiating the carboxylated silver nanowires.

It should be noted that the carboxylated silver nanowires are soaked or treated with light to make surfaces of the carboxylated silver nanowires rich in a large amount of hydrogen oxide atoms. Since 3,4-ethylenedioxythiophene: polystyrenesulfonic acid has a large number of hydrogen atoms, 3,4-ethylenedioxythiophene: polystyrene sulfonic acid can be more tightly coated on a surface of the carboxylated silver to increase density.

Step 204, heat treating 3,4-ethylenedioxythiophene and polystyrenesulfonic acid.

It should be noted that the 3,4-ethylenedioxythiophene and the polystyrenesulfonic acid may be long-chain or granular. Long-chain or granular 3,4-ethylenedioxythiophene and polystyrenesulfonic acid are subjected to heat treatment such as heating, heat preservation, and cooling to improve mechanical behavior of 3,4-ethylenedioxythiophene and polystyrenesulfonic acid particles.

Step 205, stirring 3,4-ethylenedioxythiophene, polystyrenesulfonic acid, and carboxylated silver nanowires for 3 to 120 minutes under a constant temperature water bath at 50 to 100° C. to obtain a mixture.

It should be noted that the water bath condition is to first add water to a large container, and then put the container to be heated into a container for adding water. The large container for heating the water heats the container in the large container by heating the water in the large container and then transferring the heat through the water to achieve the purpose of heating. Specifically, in the examples of the present application, 3,4-ethylenedioxythiophene and polystyrenesulfonic acid and carboxylated silver nanowires are placed in a container while stirring for 3 to 120 min, and the temperature in the container is maintained at 50 to 100° C. In this way, the mixture is obtained.

Step 206, adding an alcohol solvent, a catalyst, and a light stabilizer to the mixture to obtain the carboxylated silver/3,4-ethylenedioxythiophene: polystyrenesulfonic acid solution.

It should be noted that the alcohol solvent may be methanol, ethanol, isopropanol, or glycerin. The specific categories of the alcohol solvent are not limited in the examples of the present application. The light stabilizer may be benzophenone, benzotriazole, octyloxyphenol, or phosphite, and the like. In the examples of the present application, the specific category of the light stabilizer is not excessively limited. An alcohol solvent, a catalyst, a light stabilizer, and the like are added to the mixture to obtain a certain ratio of solid content and viscosity of the carboxylated silver/3,4-ethylenedioxythiophene: polystyrenesulfonic acid solution.

In the carboxylated silver/3,4-ethylenedioxythiophene: polystyrene sulfonic acid solution, the proportion of 3,4-ethylenedioxythiophene is 0.5% to 5%, the proportion of the polystyrene sulfonic acid accounts is 0.5% to 5%, the proportion of carboxylated silver nanowires is 0.5% to 3%, the proportion of catalyst is 1% to 3%, the proportion of alcohol solvents is 90%-95%, and the proportion of the light stabilizer is 1%-5%.

The carboxylated silver nanowires have a length of 5 to 30 um. It can be understood that the length of the carboxylated silver nanowires can be 5 um, 15 um, 20 um, 30 um, and the like. The length of the carboxylated silver nanowires in the examples of the present application is 15 um, which is a preferred embodiment.

Step 207, spraying silver carboxylate/3,4-ethylenedioxythiophene: polystyrene sulfonic acid solution onto the patterned substrate to form a wet film, and drying the wet film.

It should be noted that the carboxylated silver/3,4-ethylenedioxythiophene: polystyrene sulfonic acid solution is sprayed onto the substrate or the carboxylated silver/3,4-ethylenedioxythiophene: polystyrene sulfonate acid solution is applied to the substrate to form a wet film. The manner in which the carboxylated silver/3,4-ethylenedioxythiophene: polystyrenesulfonic acid solution is formed on the substrate to form the wet film in the examples of the present application is not limited. After the wet film is formed, the wet film is dried. Thereby, a carboxylated silver layer and a 3,4-ethylenedioxythiophene: polystyrenesulfonic acid layer are formed on the substrate.

Step 208, drying and curing the wet film at 40 to 120° C. to form the flexible conductive wire.

In the examples of the present application, since a carboxylated silver/3,4-ethylenedioxythiophene: polystyrenesulfonic acid solution is coated on the substrate of the zinc oxide nano-monomer, a highly conductive carboxylation is formed on the substrate. The silver layer and the 3,4-ethylenedioxythiophene: polystyrene sulfonic acid layer form a flexible conductive wire having good tensile properties and thermal stability.

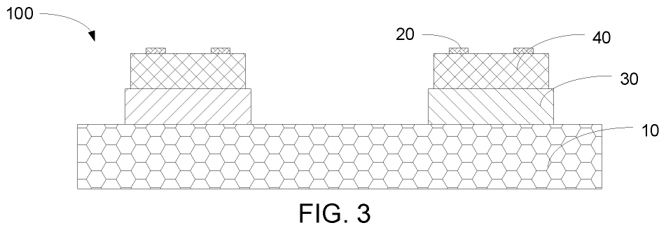

Referring to FIG. 3, FIG. 3 is a schematic structural view of a flexible conductive wire according to an embodiment of the present application.

An embodiment of the present application further provides a flexible conductive wire 10. Flexible conductive wire is typically applied to a flexible display panel. The flexible conductive wire provided in the embodiment of the present application is manufactured by the method of manufacturing the flexible conductive wire described above. Since the above-described method of manufacturing the flexible conductive wire has been described in detail, no traceability is made here.

The flexible conductive wire 10 comprises a substrate 10, a zinc oxide nano-monomer 20, a carboxylated silver layer 30, and a 3,4-ethylenedioxythiophene: polystyrenesulfonic acid layer 40. The zinc oxide nano-monomer 20 is formed on a substrate 10 and forms a patterned substrate, the carboxylated silver layer 30 is overlapped on the patterned substrate of the zinc oxide nano-monomer 20, and the 3,4-ethylenedioxythiophene: polystyrenesulfonic acid layer 40 is coated on the carboxylated silver layer 30.

In embodiments of the present application, carboxylated silver/3,4-ethylenedioxythiophene: polystyrenesulfonic acid solution is coated on the substrate of the zinc oxide nano-monomer. A highly conductive carboxylated silver layer and a 3,4-ethylenedioxythiophene: polystyrenesulfonic acid layer are formed on the substrate. The carboxylated silver layer 30 has good electrical conductivity and thermal stability. Because the 3,4-ethylenedioxythiophene: polystyrene sulfonic acid layer 40 is coated on the carboxylated silver layer 30, the 3,4-ethylenedioxythiophene: polystyrene sulfonic acid layer 40 can effectively prevent the carboxylated silver layer 30 from being oxidized. Thereby ensuring that the flexible conductive wire 100 has stable electrical conductivity. In addition, since the carboxylated silver layer 30 and the zinc oxide nano-monomer 20 are linearly joined together, stress generated during the process and during the bending process can be effectively reduced. The flexible conductive wire 100 is ensured to have better scalability, thereby forming a flexible conductive wire 100 having good tensile properties and thermal stability.

The display structure includes a display panel, a flexible conductive wire, and a drive switch. The drive switch is connected to the display panel through a flexible conductive wire. The flexible conductive wire is processed by the method of manufacturing the flexible conductive wire described above and is not described in detail in the embodiment of the present application.

It should be noted that the display structure is a bendable display structure. The flexible conductive wire also needs to be bent when the display structure is bent. However, since the flexible conductive wire of the present application has good electrical conductivity and mechanical properties, it is not easily broken and is suitable for use in the display structure of the present application.

The method of manufacturing the flexible conductive wire, the flexible conductive wire 100, and the display device provided by the embodiments of the present application are described in detail above. The principles and implementations of the present application are described herein with specific examples. The above description of the embodiments is only for the purpose of assisting in the understanding of the present application. In addition, for those skilled in the art, according to the idea of the present application, there will be changes in the specific implementation and application scope. In summary, the content of this specification should not be construed as limiting the application.

What is claimed is:

1. A method of manufacturing a flexible conductive wire, comprising:
forming a zinc oxide nano-monomer into a patterned substrate;
coating a carboxylated silver/3,4-ethylenedioxythiophene: polystyrenesulfonic acid solution on the patterned substrate; and
curing the patterned substrate and the carboxylated silver/3,4-ethylenedioxythiophene: polystyrenesulfonic acid solution to form a flexible conductive wire.

2. The method of manufacturing the flexible conductive wire according to claim 1, wherein forming the zinc oxide nano-monomer to form the patterned substrate comprises:
taking zinc nitrate hexahydrate as a precursor, hydrazine hydrate and potassium iodide as additives, and performing a hydrothermal treatment at 140 to 180° C. for 22 to 25 hours to obtain clusters of the zinc oxide nano-monomer; and
forming the zinc oxide nano-monomer into the patterned substrate by a yellow light process.

3. The method of manufacturing the flexible conductive wire according to claim 1, wherein a method of configuring the carboxylated silver/3,4-ethylenedioxythiophene: polystyrenesulfonic acid solution comprises:
stirring 3,4-ethylenedioxythiophene, polystyrenesulfonic acid, and carboxylated silver nanowires for 3 to 120 minutes under a constant temperature water bath at 50 to 100° C. to obtain a mixture; and
adding an alcohol solvent, a catalyst, and a light stabilizer to the mixture to obtain the carboxylated silver/3,4-ethylenedioxythiophene: polystyrenesulfonic acid solution.

4. The method of manufacturing the flexible conductive wire according to claim 3, wherein before stirring 3,4-ethylenedioxythiophene, polystyrenesulfonic acid, and carboxylated silver nanowires for 3 to 120 minutes under the constant temperature water bath at 50 to 100° C. to obtain the mixture, the method comprises:
soaking or irradiating the carboxylated silver nanowires.

5. The method of manufacturing the flexible conductive wire according to claim 3, wherein before stirring 3,4-ethylenedioxythiophene, polystyrenesulfonic acid, and carboxylated silver nanowires for 3 to 120 minutes under the constant temperature water bath at 50 to 100° C. to obtain the mixture, the method comprises:
heat treating 3,4-ethylenedioxythiophene and polystyrenesulfonic acid.

6. The method of manufacturing the flexible conductive wire according to claim 3, wherein the carboxylated silver nanowires have a length of 5 to 30 um.

7. The method of manufacturing the flexible conductive wire according to claim 1, wherein curing the patterned substrate and a mixture to form the flexible conductive wire comprises: spraying silver carboxylate/3,4-ethylenedioxythiophene: polystyrene sulfonic acid solution onto the patterned substrate to form a wet film, and drying the wet film.

8. The method of manufacturing the flexible conductive wire according to claim 7, wherein curing the patterned substrate and the carboxylated silver/3,4-ethylenedioxythiophene: polystyrenesulfonic acid solution to form the flexible conductive wire comprises:
drying and curing the wet film at 40 to 120° C. to form the flexible conductive wire.

9. A flexible conductive wire, comprising:
a substrate, a zinc oxide nano-monomer, a carboxylated silver layer, and a 3,4-ethylenedioxythiophene: polystyrenesulfonic acid layer, wherein the zinc oxide nano-monomer is formed on a substrate and forms a patterned substrate, the carboxylated silver layer is overlapped on the patterned substrate of the zinc oxide nano-monomer, and the 3,4-ethylenedioxythiophene: polystyrenesulfonic acid layer is coated on the carboxylated silver layer.

10. The flexible conductive wire according to claim 9, wherein the zinc oxide nano-monomer is formed into the patterned substrate by a yellow light process.

11. The flexible conductive wire according to claim 9, wherein the carboxylated silver layer comprises carboxylated silver nanowires, and the carboxylated silver nanowires having a length of 5 to 30 um.

12. The flexible conductive wire according to claim 9, wherein the carboxylated silver nanowires are soaked or illuminated.

13. The flexible conductive wire according to claim 9, wherein the 3,4-ethylenedioxythiophene: polystyrenesulfonic acid layer is subjected to heat treatment.

14. The flexible conductive wire according to claim 9, wherein the 3,4-ethylenedioxythiophene: polystyrene sulfonic acid layer comprises an alcohol solvent, a catalyst, and a light stabilizer.

15. A display device comprising a flexible conductive wire, wherein the flexible conductive wire comprises:
a substrate, a zinc oxide nano-monomer, a carboxylated silver layer, and a 3,4-ethylenedioxythiophene: polystyrenesulfonic acid layer, wherein the zinc oxide nano-monomer is formed on a substrate and forms a patterned substrate, the carboxylated silver layer is overlapped on the patterned substrate of the zinc oxide nano-monomer, and the 3,4-ethylenedioxythiophene: polystyrenesulfonic acid layer is coated on the carboxylated silver layer.

16. The display device according to claim 15, wherein the zinc oxide nano-monomer is formed into the patterned substrate by a yellow light process.

17. The display device according to claim 15, wherein the carboxylated silver layer comprises carboxylated silver nanowires, and the carboxylated silver nanowires having a length of 5 to 30 um.

18. The display device according to claim 15, wherein the carboxylated silver nanowires are soaked or illuminated.

19. The display device according to claim 15, wherein the 3,4-ethylenedioxythiophene: polystyrenesulfonic acid layer is subjected to heat treatment.

20. The display device according to claim 15, wherein the 3,4-ethylenedioxythiophene: polystyrene sulfonic acid layer comprises an alcohol solvent, a catalyst, and a light stabilizer.
